(19) United States
(12) Patent Application Publication
(10) Pub. No.: US 2023/0113445 A1
(43) Pub. Date: Apr. 13, 2023

(54) LIGHT CONTROL UNIT

(71) Applicant: ALL LED Limited, Luton (GB)

(72) Inventor: Jamie SHEMIE, Luton (GB)

(21) Appl. No.: 17/722,333

(22) Filed: Apr. 16, 2022

(30) Foreign Application Priority Data
Feb. 18, 2021 (GB) 2102282.7

(51) Int. Cl. H05B 47/19

(52) U.S. Cl. CPC H05B 47/19

(57) ABSTRACT

A light control unit (10) comprises a control module (20) and a connection module (22). The control module (20) includes a manual switch control mode that is configured to output a first control signal based on control of a power supply (28) via a position of a conventional light switch (30) connectable thereto. The control module (20) also includes a smart control mode that is configured to output a second control signal based on a command signal received wirelessly. The connection module (22) is electrically connected to the control module (20) and is connectable, in use, to a lighting circuit to control the electrical parameters of a light (14) based on the first or second control signals. The connection module (22) is configured to provide a permanent power supply to the control module (20) via connection, in use, to the said power supply (28) so that the first and second control signals independently control the electrical parameters of the light (14) regardless of the position of the manual switch (30). Moreover, the connection of the power supply (28) between the connection module (22) and the control module (20) directly connects, in use, the conventional light switch (30) to the light control unit (10), the control module (20) being configured to change the operating programme of the light control unit (10) in response to a switch sequence received from the conventional light switch (30).

This invention relates to a light control unit and to a light control assembly including such a control unit.

It is known to control the electrical parameters of a light, such as one located in a ceiling of a room, by using a wall switch, typically located in the wall of the room, to switch the light on and off or change the intensity of the light (i.e. via a dimmer switch). It is also known to control the electrical parameters of a light using wireless control, often referred to as “smart lighting”. This can be done via a “smart bulb” that communicates with a remote electronic device (such as a smart phone or other smart home devices) or a “smart switch” which replaces the convention wall switch and communicates with a remote electronic device.

Achieving smart lighting throughout a building, such as a domestic home, with the options outlined above comes with disadvantages. In particular, such smart bulbs and smart switches can be restricted to smart control only, such that they cannot be controlled by a traditional wall switch without being connected to the wireless control medium (e.g. wi-fi). Moreover, a user is required to replace all the traditional bulbs and switches in the home with smart equivalents to achieve smart lighting throughout the home, which can be costly and inconvenient. A user is also limited in choice of the aesthetic of the smart bulbs and switches that are on the market. If a user is replacing only some of the bulbs or switches, he/she may not be able to match the look of the smart bulb or switch to that of the traditional equivalents used elsewhere in the home.

According to a first aspect of the invention there is provided a light control unit comprising:
a control module including:
   a conventional light switch control mode configured to output a first control signal based on control of a power supply via a position of a conventional light switch connectable thereto;
   a smart control mode configured to output a second control signal based on a command signal received wirelessly;
a connection module electrically connected to the control module and connectable, in use, to a lighting circuit to control the electrical parameters of a light based on the first or second control signals, wherein the connection module is configured to provide a permanent supply of power to the control module via connection, in use, to the said power supply so that the first and second control signals independently control the electrical parameters of the light regardless of the position of the conventional light switch,
and wherein the connection of the power supply between the connection module and the control module directly connects, in use, the conventional light switch to the light control unit via the power supply, the control module being configured to change the operating programme of the light control unit in response to a switch sequence received from the conventional light switch.

The control module including a conventional light switch control mode as outlined above permits control of the light via a conventional light switch, e.g. a traditional wall switch. Meanwhile, the control module including a smart control mode as outlined above permits “smart” control of the light, e.g. via a smart electronic device such as a smart phone. Moreover, the connection module being configured to provide a permanent power supply to the control module via connection, in use, to the power supply means that each of the conventional light switch control mode and the smart control mode can independently control the light regardless of the position of the conventional light switch.

In other words, it does not matter if the conventional light (e.g. wall) switch is turned off, the light can still be controlled by the smart control mode of the control module (e.g. a user can use their smart phone to turn the light on). It also does not matter if there is no wireless connection to the control module (e.g. there is no wifi connection), the light can still be controlled by the conventional wall switch in the traditional manner. This is because the convention light switch is configured to be connected to live power supply, so it is able to control the switch via the power supply, and the live power supply is also connectable, in use, to the control module. Thus, the control module is always active.

This has the practical benefit of the light not being restricted to one method of control. Therefore, if a person entering a room is not able to connect to the wireless control of the light control unit (e.g. he/she does not have the correct application on their smart phone), then that person can still operate the light in the traditional manner via the conventional light switch. Likewise, even if the conventional light switch is turned to the off position such that it is not supplying power to the light, the light can still be controlled via the smart control mode of the control module.

In addition to the foregoing, the control module being connectable to a conventional light switch, i.e. the conventional light switch not forming part of the light control unit, means that an existing light switch can be connected to the control module (e.g. a traditional wall switch). Therefore, the existing wall switch does not need to be replaced.

Moreover, the light control unit being further connected to the conventional light switch via the power supply allows the control module to be able to change the operating programme of the light control unit in response to a switch sequence received from the conventional light switch. It will be understood that changing the operating programme of the light control unit is different to changing the electrical parameters of the light (e.g. switching the light on/off). The operating programme of the light control unit changes the mode of the overall unit so that it is ready to receive instructions or connection, or to re-programme the whole unit. Thus, by using a conventional wall switch, the user can perform a switching sequence to change the operating programme of the unit without having to physically access the unit. This is especially advantageous because the unit would typically be located in a ceiling or wall of a room, which is difficult to access. In known systems, the operating programme of the unit may be controlled by pressing buttons on the unit itself, thus a user would need to physically access the unit which, as outlined, is not usually convenient to do so.

The operating programme of the light unit comprises one or more of the following: factory reset mode, network pairing mode, remote control pairing mode, circuit identification mode, normal operating mode.

Such modes are described in further detail below in relation to the drawings. Each mode changes the mode of the light control unit in some way, e.g. to receive instructions or to make connection to a network or other device or to restart or reprogramme the unit.

The said power supply may be mains power supply or a separate low voltage power supply.

A separate low voltage supply can be used if a user does not have the option of taking live mains cable to the conventional light switch.

Preferably the connection module includes a plurality of terminals for facilitating the necessary connections of the control module to permit control of the electrical parameters of the light.

The inclusion of such terminals provides a means for connection to existing wiring of the conventional light switch, the light and power supply to permit the light control unit to be retrofitted to an existing light circuit.

Optionally, the connection module includes a live supply terminal for connecting the power supply between the control module and the conventional light switch, in use, to provide a permanent power supply to the control module and to the convention light switch.

Providing such a live supply terminal facilitates connection of the power supply to the light control unit to provide the permanent power supply required to allow the light to be controlled independently by the conventional light switch control mode and smart control mode, as well as to facilitate the change in operating programme of the light control unit in response to a switch sequence received from the conventional light switch.

The connection module may include a live output terminal for connecting the control module, in use, to the light.

Providing such a live output terminal facilitates control of the light by each of the conventional switch control mode and the smart control mode.

The connection module may include a light input terminal for connecting the control module, in use, to the conventional light switch.

Providing such a light input terminal facilities circuit connection between the control module and the conventional light switch.

The connection module may include a neutral terminal for making a neutral connection in the lighting circuit in use.

Optionally, the light control unit includes a control unit housing, wherein the control module and the connection module is part of the control unit housing.

The light control unit is therefore packaged in a single unit, with the control module and connection module forming part of that package, thus making it easier to retrofit the light control unit to an existing light circuit.

Preferably, the control module is configured to wirelessly receive a command signal from a remote electronic device including one or more of: a smart phone, a smart home device, a controller, a gateway, a router, a wifi device, a Bluetooth device, a zigbee device, an RF device, a mobile phone, GSM.

Moreover, the first and second control signals may be configured to independently control electrical parameters of the light that include one or more of: switching the light on or off, changing the intensity of the light, changing the colour of the light, switching a remote electronic device in wireless communication with the control module on or off.

Such configurations mean that the control module is able to connect to and receive instructions from a remote electronic device to control different electrical parameters of the light or the remote electronic device in the smart control mode.

According to second aspect of the invention there is provided a light control assembly comprising:
a light control unit as described hereinabove;
a conventional light switch connected to the light control unit via the said power supply; and
a light connected to the light control unit.

The advantages of the light control unit of the first aspect of the invention and its embodiments applies mutatis mutandis to the light control assembly of the second aspect of the invention and its embodiments.

Preferred embodiments of the invention will now be described, by way of non-limiting examples, with reference to the accompanying drawings in which:

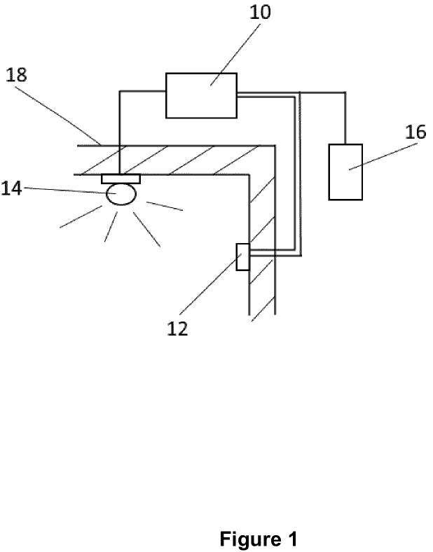

FIG. 1 is a schematic of a light control unit according to a first embodiment of the invention in situ;

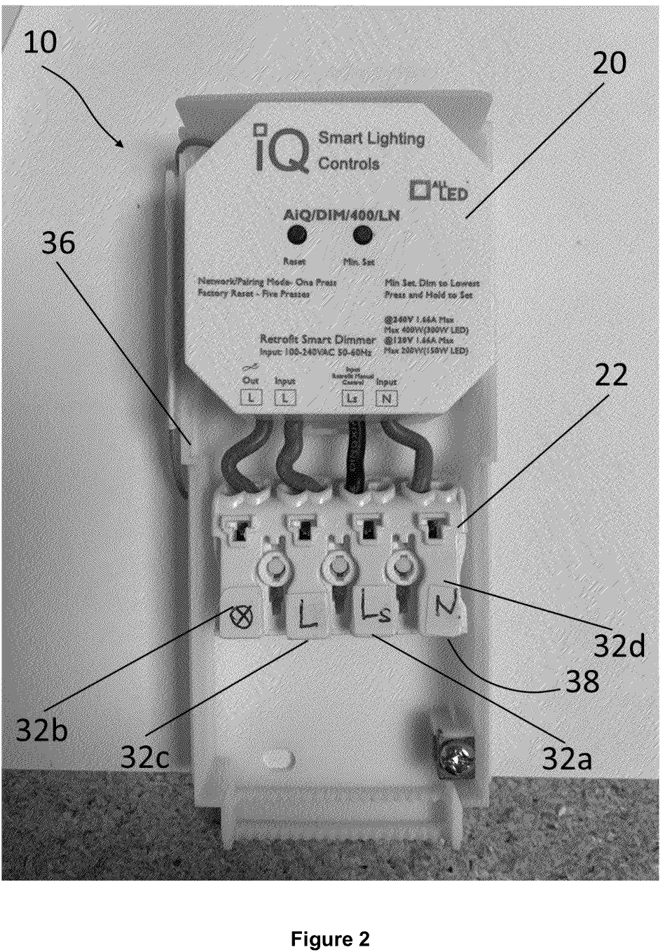

FIG. 2 shows the light control unit of the first embodiment of the invention;

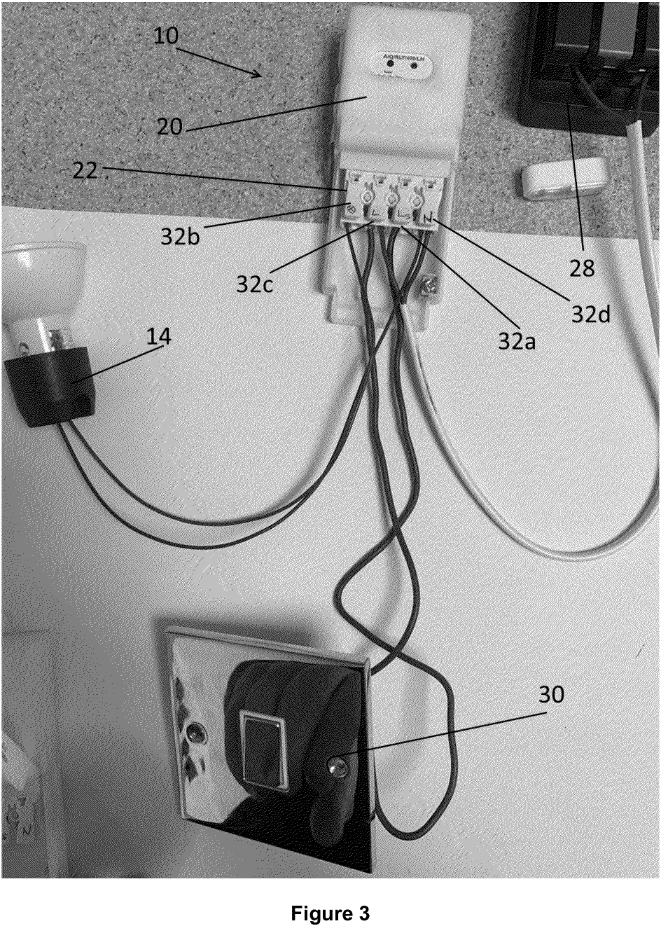

FIG. 3 shows the light control unit of the first embodiment of the invention connected to a light, conventional light switch and mains power supply via wires;

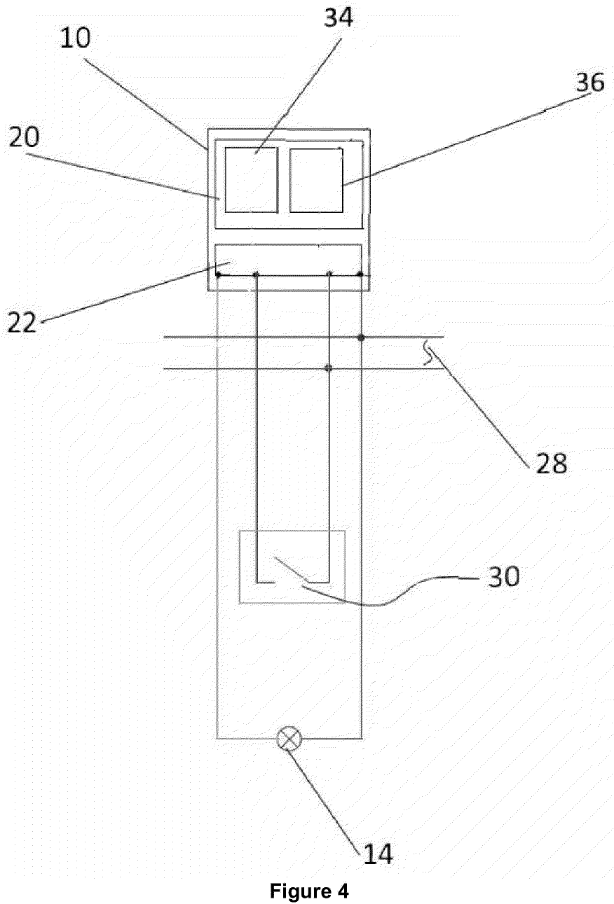

FIG. 4 is a circuit diagram of the light control unit of the first embodiment and its connections in situ;

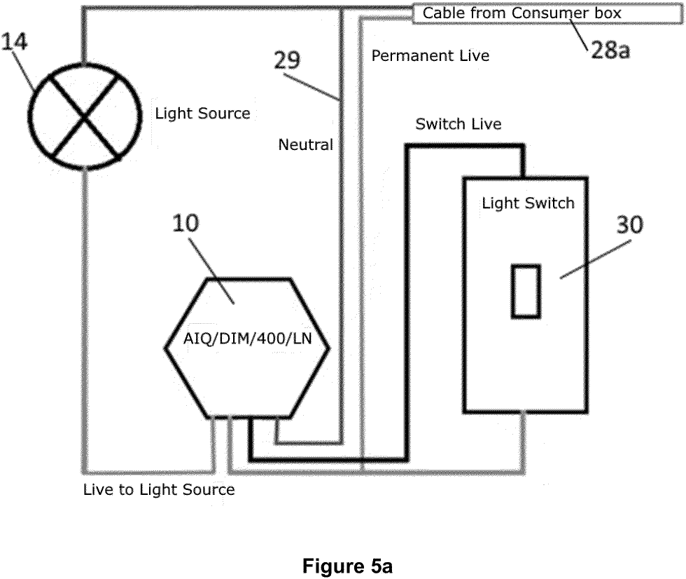

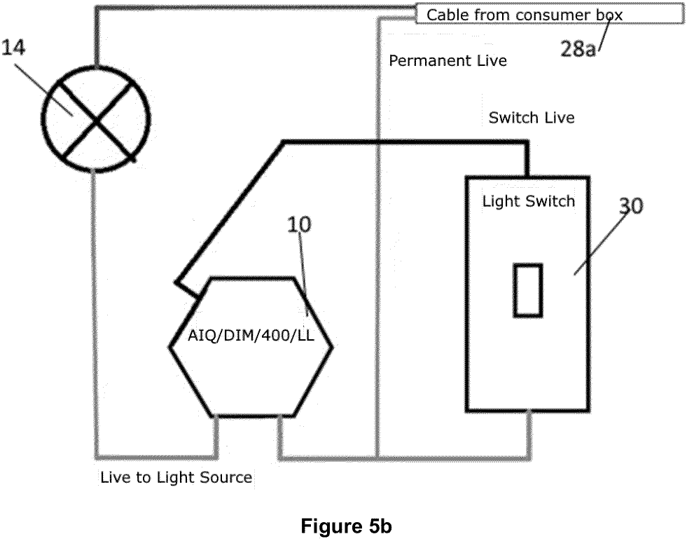

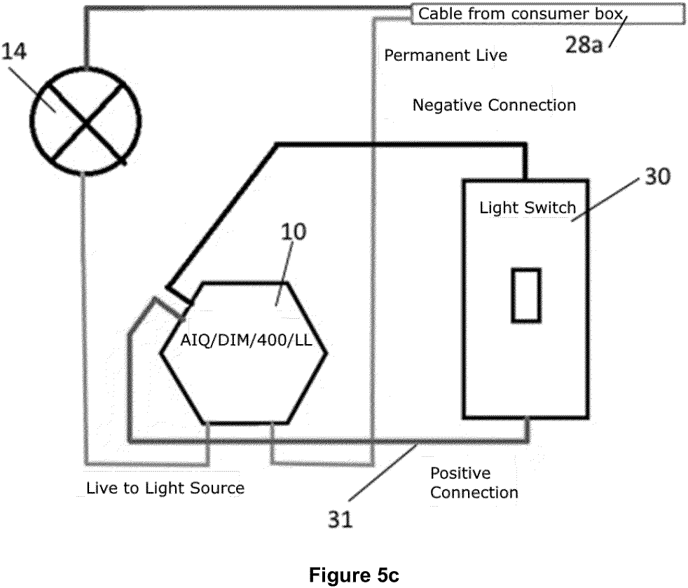

FIG. 5a is a first embodiment circuit diagram of the light control unit and its connections in situ connected to mains power supply and with a neutral cable;

FIG. 5b is a second embodiment circuit diagram of the light control unit and its connections in situ connected to mains power supply without a neutral cable; and

FIG. 5c is a third embodiment circuit diagram of the light control unit and its connections in situ connected to a low voltage power supply.

A light control unit 10 according to a first embodiment of the invention is shown in FIGS. 1 to 5c and is designated generally by reference numeral 10.

In FIG. 1, the light control unit 10 is shown in situ with a lighting circuit. In particular, the light control unit 10 is connected between a wall switch 12 and a ceiling light 14. A fuse box 16 is also connected between the light control unit 10 and the wall switch 12. When the wall switch 12 is controlled, it switches a convention light switch (not shown in FIG. 1 but described in more detail in relation to FIG. 4) which in turn controls the ceiling light 14.

The wall switch 12 may be an on/off switch to control the intensity of the ceiling light 14.

The control unit 10 is located in the ceiling 18 of the room in which the ceiling light 14 is located. The control unit 10 may be located elsewhere, e.g. within the walls of the room, behind the light switch, or in the ceiling or walls of another room. However, it is intended that the control unit 10 is hidden from view.

The light control unit 10 is shown in more detail in FIGS. 2 to 4. The light control unit 10 includes a control module 20 and a connection module 22.

The control module 20 includes a conventional light switch control mode and a smart control mode. In the conventional light switch control mode, the control module 20 is configured to output a first control signal based on control of a power supply 28 via a position of a conventional wall switch 30 connected thereto. In the smart control mode, the control module 20 is configured to output a second control signal based on a command signal received wirelessly.

The connection module 22 electrically connects the control module 20 to the light 14. The electrical parameters of the light 14 are able to be controlled based on the first or second control signals. Moreover, the connection module 22 is configured to provide a permanent power supply to the control module 20 via its connection to the power supply 28 so that the first and second control signals independently control the electrical parameters of the light 14 regardless of the position of the conventional wall switch 30.

Moreover, the connection of the power supply 28 between the connection module 22 and the control module 20 directly connects the conventional wall switch 30 to the light control unit 10 and allows the control module 20 to change the operating programme of the light control unit 10 in response to a switch sequence received from the conventional wall switch 30. Example operating programmes and their switching sequences are described in more detail below. In each case, the switching sequence from the conventional light switch 30 activates a pre-set operating programme of the light control unit via a programmed chip (or other suitable device).

Factory reset mode will remove all paired connections (i.e. any device which is wirelessly connected to the control module to control it in the smart control mode). The load (i.e. ceiling light in this example 14) will indicate that the operation was successful, e.g. by flashing. Alternatively, or in addition, the light control unit 10 itself may indicate that the operation was successful, e.g. by flashing a light on the unit 10.

The switching sequence to operate the factory reset mode may be: toggle the conventional light switch 30 seven times, as follows: OFF>ON>OFF>ON>OFF>ON>OFF

After the factory reset mode has been completed, the light control unit 10 will automatically go into network pairing mode. Network pairing mode enables the user to connect the control module to a network hub/gateway. After a pre-determined amount of time, e.g. 60 s, the unit 10 will cease network pairing mode if no pairing is found. After the time limit has ended, the light control unit will return to a normal operating state. If successful pairing is established, the light will indicate that the operation was successful, e.g. by flashing.

If a user wants to run the networking pairing mode again, then the user commences the factory reset mode (i.e. by toggling the switch as outlined above) so that network pairing mode is automatically established. In this way, factor reset mode and networking pairing mode in this example has the same switching sequence. In other embodiments, the two modes may have separate switching sequences.

Remote control pairing mode enables the user to connect or disconnect a remote device, such as a handheld remote, to the light control unit. In this example, this mode will run for 3 minutes or until a connection has been established. If successful, the light will flash.

The switching sequence to operate the remote control pairing mode may be: toggle the conventional light switch 30 four times, as follows: OFF>ON>OFF>ON.

Circuit identification mode allows the user to identify which lighting circuit(s) (i.e. which conventional wall switches) is/are connected to the light control unit. In this mode, the lighting control unit is made to turn on and off continually until the conventional wall switch is toggled once.

The switching sequence to operate the circuit identification mode may be: toggle the conventional light switch 30 three times, as follows: OFF>ON>OFF.

The normal operating mode of the light control unit will resume once a mode time limit has exceeded or stopped. In the normal operating mode, the light control unit can control the light from the conventional light switch and from the network hub/gateway to which it is wirelessly connected.

It will be understood that other operating programmes of the light control unit 10 may be controllable via a switching sequence of the conventional light switch 30. Moreover, it will be appreciated that the switching sequences may differ in other embodiments.

The connection module 22 includes a plurality of terminals 32a-32d for facilitating the necessary connections between the control module 20 and the light 14, power supply 28 and conventional wall switch 30.

In particular, the connection module 22 includes a live supply terminal 32c which is connected to the power supply 28 and to the conventional wall switch 30. The live supply terminal 32c therefore defines a permanent live connection between the control module 20 and the conventional wall switch 30. In other words, the power supply from the power supply 28 is supplied to the control module 20, and this power is also supplied down to the conventional wall switch 30 via the control module 20. Thus, the mains power is shared between the control module 20 and the conventional wall switch 30 at the live supply terminal 32c.

The connection module 22 also includes a light input terminal 32a connected to the conventional wall switch 30 which allows power from the conventional wall switch 30 to enter back up into the control module 20.

The connection module 22 also includes a live output terminal 32b which is connected to the light 14 to selectively provide power to the light 14 via either the conventional light switch control mode (i.e. first control signal) or the smart control mode (i.e. second control signal).

The connection module 22 further includes a neutral terminal 32d which is shared between the light 14 and the power supply 28.

As shown schematically in FIG. 4, the control module 20 includes a switch 34 and a communication chip 36 integral to the control module 20. The communication chip 36 is configured to receive the wireless command signal and output a control signal to the switch 34 which, in turn, outputs the second control signal to control the light 14.

The light control unit 10 further includes a control unit housing 36 which houses the control module 20 and the connection module 22. Although not shown, the housing 36 preferably has a cover to protect the control module 20 and the connection module 22.

Each of the terminals 32a-32d includes one or more terminal connection means 38 for receiving and connecting a wire.

FIGS. 5a to 5c show the light control unit 10 in situ with a lighting circuit to connect the light 14, conventional light switch 30 and light control unit 10 to one another via a power supply. In each example, the same light control unit 10 is used and is able to be retro fitted to the existing lighting circuit, e.g. within a home.

In the first example shown in FIG. 5a, the light control unit 10 is connected to the conventional switch 30 via a mains power supply 28a with a neutral connection 29. In this example, the conventional light switch 30 is powered by mains voltage (e.g. 240 V).

In the second example shown in FIG. 5b, the light control unit 10 is connected to the conventional switch 30 via a mains power supply 28a without a neutral connection. In this example, the conventional light switch 30 is powered by mains voltage (e.g. 240 V).

The first and second example (FIGS. 5a and 5b) illustrate how the light control unit 10 can be fitted with different existing wiring configurations of a light circuit. In this way, the unit 10 is able to operate in two modes: Live Live or Live Neutral.

In the third example shown in FIG. 5c, the light control unit 10 is connected to the conventional switch 30 via a separate power supply 31. In this example, the conventional light switch 30 is powered by the low volage power supply (e.g. 500 V).

The light control unit 10 is operated to change the mode of the light 14 as follows. When the conventional wall switch 30 is operated, e.g. pressed to the on/off position, this in turn activates the control module 20 in the conventional light switch control mode. When the conventional wall switch 30 is pressed between the on/off positions, a potential difference causes either a “zero” or “full” first control signal which is output to the light 14 via the live output terminal 32b. When the first control signal is “zero”, the light 14 is not powered and so switches off and when the first control signal is “full” it permits power from the power supply 28 to switch the light on via the control module 20 operating in the conventional light switch control mode. More specifically, the shared power supplied to the module 20 from the power supply 28 at the live supply terminal 32c goes to the conventional switch 30 and is allowed to enter back up to the control module 20 at the light input terminal 32a upon activation of the wall switch. This creates the “full” first control signal which powers the light 14 via the live output terminal 32b.

When the control module 20 is operated in the smart control mode, a second control signal based on a command signal received wirelessly is created. For example, a remote electronic device, such as a smart phone, other smart home device or a remote controller, may receive a command from a user. The command may be an audio command, such as voice control, or may be from operating an app on the smart device. The command signal is sent wirelessly to the control module 20, e.g. via a gateway, Wifi, Bluetooth, Zigbee, a mobile device, voice control etc. The command signal is received by the communication chip 36 which creates a control signal which is sent to the integrated switch 34. The switch 34, in turn, outputs the second control signal to the light 14.

Alternatively, the control module 20 may directly receive a command from a user, such as a voice command to allow it to operate in the smart control mode.

Because of the permanent live shared connection to the control module 20 via the live supply terminal 32a, even when the conventional wall switch 30 is open, power from the power supply 28 can be nevertheless supplied to the control module 20 to output power to the light 14 via the live output terminal 32b when operating in the smart control mode.

In this way, the control signals generated by the control module 20 in each of the conventional light switch control mode and the smart control mode control the light 14 completely independently from one another. For example, the wall switch 12 could be at a first position so that the light 14 is off and subsequently the smart control mode can be activated to turn the light 14 on at a certain percentage of light. The smart control mode can then be activated to turn the light 14 off. Then, the conventional light switch 30 could be moved to the opposite position which would turn the light 14 on.

1. A light control unit comprising:
a control module including:
a conventional light switch control mode configured to output a first control signal based on control of a power supply via a position of a conventional light switch connectable thereto;
a smart control mode configured to output a second control signal based on a command signal received wirelessly;
a connection module electrically connected to the control module and connectable, in use, to a lighting circuit to control the electrical parameters of a light based on the first or second control signals, wherein the connection module is configured to provide a permanent supply of power to the control module via connection, in use, to the said power supply so that the first and second control signals independently control the electrical parameters of the light regardless of the position of the conventional light switch,
and wherein the connection of the power supply between the connection module and the control module directly connects, in use, the conventional light switch to the light control unit, the control module being configured to change the operating programme of the light control unit in response to a switch sequence received from the conventional light switch.

2. A light control unit according to claim 1 wherein the operating programme of the light unit comprise one or more of the following: factory reset mode, network pairing mode, remote control pairing mode, circuit identification mode, normal operating mode.

3. A light control unit according to claim 1 wherein the said power supply is mains power supply or a separate low voltage power supply.

4. A light control unit according to claim 1 wherein the connection module includes a plurality of terminals for facilitating the necessary connections of the control module to permit control of the electrical parameters of the light.

5. A light control unit according to claim 4 wherein the connection module includes a live supply terminal for connecting the power supply between the control module and the conventional light switch, in use, to provide a permanent supply of power to the control module and to the conventional switch.

6. A light control unit according to claim 4 wherein the connection module includes a live output terminal for connecting the control module, in use, to the light.

7. A light control unit according to claim 4 wherein the connection module includes a light input terminal for connecting the control module, in use, to the conventional switch.

8. A light control unit according to claim 4 wherein the connection module includes a neutral terminal for making a neutral connection in the lighting circuit in use.

9. A light control unit according to claim 1 further including a control unit housing, wherein the control module and the connection module are part of the control unit housing.

10. A light control unit according to claim 1 wherein the control module is configured to wirelessly receive a command signal from a remote electronic device including one or more of: a smart phone, a smart home device, a controller, a gateway, a router, a wifi device, a Bluetooth device, a zigbee device, an RF device, a mobile phone, GSM, to permit operation of the control module in the smart control mode.

11. A light control unit according to claim 1 wherein the first and second control signals are configured to independently control electrical parameters of the light that include one or more of: switching the light on or off, changing the intensity of the light, changing the colour of the light, switching a remote electronic device in wireless communication with the control module on or off.

12. A light control assembly comprising:
a light control unit according to claim 1;
a conventional light switch connected to the light control unit via the said power supply; and
a light connected to the light control unit.
